(19) United States
(12) Patent Application Publication
(10) Pub. No.: US 2025/0303333 A1
(43) Pub. Date: Oct. 2, 2025

(54) AN AIR FILTER FRONT END PLATE, AN AIR FILTER CARTRIDGE AND AN AIR FILTER ARRANGEMENT

(71) Applicant: Camfil Aktiebolag, Stockholm (SE)

(72) Inventors: Frank SEALES, Lachine (CA); Joshua KOHN, Lachine (CA)

(21) Appl. No.: 18/881,757

(22) PCT Filed: Jul. 10, 2023
(86) PCT No.: PCT/SE2023/050727

§ 371 Date: Jan. 7, 2025

(30) Foreign Application Priority Data
Jul. 11, 2022 (SE) 2250893-1

(51) Int. Cl. B01D 46/24; B01D 46/60

(52) U.S. Cl. CPC B01D 46/2414; B01D 46/60; B01D 2265/025; B01D 2265/06

(57) ABSTRACT

An air filter front end plate (1) configured to close off a front end (102) of a hollow air filter media pack (101), the front end plate comprises a bowl part (2) and a flange part (3) located along a periphery (4) of the bowl part (2), said bowl part including a connection point (5) located at the centre of the bowl part and being configured to be connected to a front end (132) of a mounting stand (131) in an air filter arrangement, the bowl part (2) extending from a forward end (21) toward a rearward end (22) of the air filter front end plate and is configured to be at least partially inserted into a front end opening (102) of the hollow air filter media pack (101), and wherein the bowl part (2) has a recurved shape with a first curved portion (7) located closer to said forward end (21) and a second curved portion (8) located closer to said rearward end (22), wherein said first curved portion (7) has a convex shape in relation to a centre line through the air filter front end plate and said second curved portion (8) has a concave shape in relation to said centre line, whereby the connection point (5) is located in a position forward of the second curved portion (8). The disclosure further relates to a pressure indicator washer, a pressure indicator assembly, a front end plate, an air filter cartridge (110) and an air filter arrangement (200).

### TECHNICAL FIELD

The present disclosure relates to air filtration and in particular to an air filter front end plate, an air filter cartridge and an air filter arrangement. The present disclosure further relates to a pressure indicator washer, a pressure indicator assembly, an air filter front end plate, an air filter cartridge and an air filter arrangement, comprising the pressure indicator washer.

### BACKGROUND ART

Hollow air filters typically include some kind of support arrangement to hold a hollow air filter media pack in position against a base plate or tube sheet in an air filter arrangement, and the filter is usually mounted on a mounting stand to keep it in position. It is important that the air filter is easy to install in an air filter arrangement. However, there is a continuous desire to improve performance and reduce cost within air filtration, and there is thus a need for improved air filters that show improved properties and are easy to manufacture and to install.

### SUMMARY

The present disclosure relates to an air filter front end plate configured to close off a front end of a hollow air filter media pack, the front end plate comprises a bowl part and a flange part located along a periphery of the bowl part, the bowl part including a connection point located at the centre of the bowl part and being configured to be connected to a front end of a mounting stand in an air filter arrangement. The bowl part extends from a forward end toward a rearward end of the air filter front end plate and is configured to be at least partially inserted into a front end opening of the hollow air filter media pack, and wherein the bowl part has a recurved shape with a first curved portion located closer to the forward end and a second curved portion located closer to the rearward end, wherein the first curved portion has a convex shape in relation to a centre line through the air filter front end plate and the second curved portion has a concave shape in relation to the centre line, whereby the connection point is located in a position forward of the second curved portion.

The second curved portion of the bowl part may suitably be configured to form a recess on a rearward side of the air filter front end plate, said recess being adapted to receive a connecting member attached to the mounting stand.

The connection point in the bowl part may suitably comprise an aperture and a connection arrangement that is located on a forward side of the bowl part, said connection arrangement of the air filter front end plate comprises a resilient compression element and a pressure cap (pressure washer), the resilient compression element being arranged between the bowl part and the pressure cap. The resilient compression element may include two or more protruding portions extending in a forward direction from a base portion.

The resilient compression element advantageously has a central opening configured to receive a connection member to be inserted through the aperture in the bowl part, and the resilient compression element may suitably be an integral one piece element, preferably made of resilient polymeric material.

The resilient compression element may advantageously be configured to interlock with an edge of the aperture in the bowl part to be attached to the bowl part, and is preferably obtained by co-injection molding.

The pressure cap has preferably a central opening configured to receive the connection member, and may further advantageously comprise one or more indicator tabs configured to be pushed in a forward direction by the compression element when a pressure applied on the pressure cap and the compression element has reached a predetermined pressure limit.

The bowl part preferably includes a ramp portion adjacent to the flange part, said ramp portion being configured to be inserted into the front end opening and to fit into a front end opening of an air filter media supporting cage arranged on an interior side of the hollow air filter media pack.

The flange part may suitably include an air filter media retaining recess configured to receive the front end of the hollow air filter media pack.

The present disclosure also relates to an air filter cartridge comprising the above air filter front end plate, an air filter media supporting cage, a hollow air filter media pack, and a rear end plate, wherein the air filter media supporting cage is arranged on an interior side of the hollow air filter media pack and the air filter front end plate is inserted into a front end opening of the air filter media supporting cage and into the front end opening of the air filter media pack.

Further, the present disclosure also relates to an air filter arrangement comprising the air filter cartridge, a mounting stand, and an air filter base plate comprising an air flow opening, wherein the filter cartridge is fastened to the mounting stand and the rear end plate is directed toward the base plate, and wherein a front end of the mounting stand is connected to the air filter front end plate of the filter cartridge at the connection point. A second filter cartridge with an open front end plate may be arranged between the air filter cartridge of and the base plate. The mounting stand is preferably a tripod.

The present disclosure also relates to a pressure indicator washer that comprises a main portion having a central opening configured to receive a connection rod of a mounting stand, the main portion having a front side and a rear side, the indicator washer further comprising at least one indicator tab provided in the main portion, the indicator tab including a contact portion protruding from the rear side of the main portion. The indicator tab is suitably configured to be pushed out from the front side of the main portion when a pressure applied on a rear side of the contact portion has reached a predetermined pressure limit. The indicator tab may preferably comprise a weakened outline part, said weakened outline part preferably being a perforation line with intermediate bridges or a weakening line. The indicator tab is suitably connected to the pressure washer by a hinge portion. The protruding contact portion of the indicator tab and the weakened outline part of the indicator tab are advantageously made of different materials. The pressure indicator washer suitably comprises a contact area located on the front side of the main portion, said contact area surrounding the central opening and being configured to receive a force applied by a fastening element being attached to a connection rod when mounted, said fastening element preferably being a nut threaded onto the connection rod when mounted. In some embodiments, the pressure indicator washer may comprise a plurality of pressure indicator tabs.

The present disclosure further relates to a pressure indicator assembly comprising the pressure indicator washer described above, and a compression element having a central opening and at least one protruding element. The central opening of the compression element and the central opening of the pressure indicator washer is configured to receive a connection rod of a mounting stand. In the assembly, the pressure indicator washer is configured to be positioned onto the compression element such that the central opening of the pressure indicator washer coincides with the central opening of the compression element when assembled, and the at least one protruding element is directed toward the rear side of the pressure indicator washer. The indicator tab of the pressure indicator washer has a position which is aligned with the position of the at least one protruding element of the compression element. The compression element is a preferably resilient compression element.

The pressure indicator assembly may preferably comprise a base plate adapted to be positioned on a rear side of the compression element opposite to the pressure indicator washer. The base plate has a central opening and has preferably a circumferential flange adapted to engage with the compression element when assembled. The pressure indicator washer may suitably comprise a circumferential flange adapted to engage with the compression element when assembled.

Further, the present disclosure relates to an air filter front end plate configured to close off a front end of a hollow air filter media pack. The front end plate comprises a centre part and a flange part located along a periphery of the centre part, the centre part including a connection point located at the centre thereof and being configured to be connected to a front end of a mounting stand in an air filter arrangement, wherein a pressure indicator washer as described above is arranged at the a connection point. Advantageously, the pressure indicator washer is comprised in a pressure indicator assembly as described above.

The present disclosure further relates to an air filter cartridge comprising an air filter front end plate described above, a hollow air filter media pack, and a rear end plate, and to an air filter arrangement comprising the air filter cartridge, a mounting stand, and an air filter base plate comprising an air flow opening, wherein the filter cartridge is fastened to the mounting stand and the rear end plate is directed toward the base plate, and wherein a front end of the mounting stand is connected to the air filter front end plate of the filter cartridge at a connection point, such that the connection rod is inserted through the central opening of the pressure indicator washer and a fastening element is tightened with respect to the connection rod, wherein the indicator tab is adapted to be pushed out from the front side of the main portion of the pressure indicator washer when a pressure applied on a rear side of the contact portion of the washer has reached a predetermined pressure limit. A second air filter cartridge can be arranged between the air filter cartridge and the air filter base plate. The connection rod is suitably a part of the mounting stand, said mounting stand preferably being a tripod.

The present disclosure will become apparent from the detailed description given below. The detailed description and example embodiments disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described since such device may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### DETAILED DESCRIPTION

The present disclosure relates to an air filter front end plate configured to close off a front end of a hollow air filter media pack. The air filter front end plate is suitable for use in any kind of hollow air filter, and is particularly useful in pulse filters, i.e. air filters where a short compressed air pulse is directed regularly in a direction opposite to the main filtration direction in order to clean the filter. The filter media pack can be of any suitable type, and may typically be a hollow structure where a pleated filter media pack extend in the circumference direction and where the pleats extend in the length direction of the cage wall members.

The air filter front end plate according to the present disclosure aims at allowing the use different construction materials in a filter cartridge where it is to be used and in a mounting stand by means of which the filter cartridge is to be mounted in an air filter arrangement. Details and properties of the air filter front end plate will be described in more detail below.

The present disclosure thus also relates to an air filter cartridge comprising the air filter front end plate, an air filter media supporting cage, a hollow air filter media pack, and a rear end plate, wherein the air filter media supporting cage is arranged on an interior side of the hollow air filter media pack and the air filter front end plate is inserted into a front end opening of the air filter media supporting cage and into the front end opening of the air filter media pack.

Further, the present disclosure also relates to an air filter arrangement comprising the air filter cartridge, a mounting stand, and an air filter base plate, comprising an air flow opening, wherein the filter cartridge is fastened to the mounting stand and the rear end plate is directed toward the base plate, and wherein a front end of the mounting stand is connected to the air filter front end plate of the filter cartridge at the connection point. A gasket is preferably attached to the rearward surface of rear end plate to obtain proper sealing. The base plate may be part of a mounting frame or tube sheet. A second filter cartridge with an open front end plate may be arranged between the air filter cartridge of and the base plate to form an air filter cartridge assembly. The mounting stand is preferably a tripod to allow easy installation of the air filter cartridge.

In the present disclosure, the terms front and forward refer to a position or direction at a closed end of a hollow air filter structure, e.g. positioned farthest away from a base plate, onto which an air filter cartridge is mounted. In analogy, the terms rear and rearward refer to a position or direction opposite to the closed end of a hollow air filter structure, e.g. positioned closer to the base plate or a tube sheet.

When the air filter cartridge is mounted in an air filter arrangement a mounting device is used for applying tension between the front end plate and the base plate. Installations of hollow air filter cartridges commonly use a mounting device comprising one or more steel rods or bars attached at an opening in the base plate, allowing air to enter or exit the filter. One example is a tripod mounting stand, in which steel bars are mounted evenly distanced in a circumference direction around of the air passage opening. The bars converge into a central common section at the front end of the tripod and ends with a single centrally located attachment point where an attachment member can be provided, preferably in the form of a threaded rod, but alternatively it can include hooks or other fastening means for securing the filter. When the air filter cartridge is mounted against the base plate, the attachment member may exit through a hole in the front end plate so that the fastening means are available to engage with a nut, lever hook or other half of the fastening mechanism. When the air filter cartridge is mounted to the tripod with a threaded central rod, a nut is placed over the threaded rod and fastened, and the filter media pack and the front end plate will be pressed against the base plate to make sure that the filter cartridge is sufficiently supported and sealed to the base plate.

Another example is a mounting rod having a threaded first end and a flange at a second end, and which is inserted from the front end of the filter cartridge through the front end plate and all the way to the rear end of the filter cartridge of cartridge assembly and to engage the threaded first end with a threaded mounting member attached across the air passage opening.

There is a desire to be able to use an air filter media supporting cage made of plastic material in the air filter cartridge, to allow effective manufacture and to be able to obtain very complicated structures including various elements that can improve air filter performance and reduce cost. However, during operation of air filter installation, the temperature may vary considerably and metal parts and plastic parts can expand very differently as the temperature varies. Plastic materials that have a coefficient of thermal expansion similar to that of steel exist, but are relatively expensive. To be able to make use of different construction materials with different temperature expansion properties in a hollow air filter cartridge and its mounting device in an air filter arrangement or housing, it is important to avoid over or under pressure of the sealing between the filter cartridge and the base plate and to avoid non-elastic deformation of the filter cartridge or the mounting stand.

If the mounting stand is made of the same material as the supporting cage in the filter cartridge, or a material with the same coefficient of thermal expansion, then the seal will be maintained across shifting temperatures. However, if the coefficient of thermal expansion is different such as the case where the mounting device is made of steel rods and the supporting cage in the filter is made of plastic or composite materials, then proper sealing may not be maintained across wide temperature fluctuations. In such a case where plastics or composites have a coefficient of thermal expansion higher than that of steel, increases in temperature will cause the mounting stand to elongate less than the filter and reductions in temperature will cause the mounting device to shrink less than the supporting cage in the filter. If the typical service temperature is higher than the mounting temperature, the supporting cage in the filter will expand in length by more than the mounting stand. This may lead to additional stress on the filter cartridge which must be withstood without damage. If the typical service temperature is lower than the mounting temperature, the filter will shrink by more than the mounting stand and the filter seal integrity can be compromised leading to air bypass.

Accordingly, there is a desire to obtain an air filter cartridge in which a filter media supporting cage can be used, which is made of plastic or composite material, such as non-reinforced ABS, and which can still be installed in an air filter arrangement by means of a mounting stand of steel or other metal, without the risk of filter cartridge deformation or leakage.

The front end plate according to the present disclosure comprises a bowl part and a flange part located along a periphery of the bowl part, and the bowl part includes a connection point located at the centre of the bowl part, which is configured to be connected to a front end of a mounting stand in an air filter arrangement. The bowl part extends from a forward end toward a rearward end of the air filter front end plate and is configured to be at least partially inserted into a front end opening of the hollow air filter media pack, and wherein the bowl part has a recurved bow shape with a first curved portion located closer to the forward end and a second curved portion located closer to the rearward end, wherein the first curved portion has a convex shape in relation to a centre line through the air filter front end plate and the second curved portion has a concave shape in relation to the centre line, whereby the connection point is located in a position forward of the second curved portion. The two curved portions allow the front end plate to flex when a certain degree of tension is applied to the connection point in an axial direction to allow some of the additional force due to high temperature thermal expansion to be taken up by the recurve bow shape flexing, instead of being transferred to the filter media support cage where it can cause a break. Thus, the front end cap can be made of rigid plastic and still be sufficiently flexible. Accordingly, when temperature increases and filter media supporting cage tries to expand in size, the front end cap is able to reversibly bend instead of only forcing against the mounting nut and building up a high stress.

The second curved portion of the bowl part may suitably be configured to form a recess on a rearward side of the air filter front end plate, said recess being adapted to receive a connecting member attached to the mounting stand, and to facilitate self-centering of a connection rod used as attachment member inserted from a rearward side of the bowl part, which makes it easier to align with a mounting stand, e.g. in the form of a tripod.

The connection point in the bowl part may suitably comprise an aperture and a connection arrangement that is located on a forward side of the bowl part, said connection arrangement of the air filter front end plate comprises a resilient compression element and a pressure cap (pressure washer), the resilient compression element being arranged between the bowl part and the pressure cap. In this disclosure the terms “pressure cap” and “pressure washer” are used interchangeably, referring to the same or similar component.

The resilient compression element and the pressure cap preferably both have a central opening configured to receive a connection member in the form of a connection rod to be inserted through the aperture in the bowl part.

The resilient compression element may include two or more protruding portions extending in a forward direction from a base portion, in order to improve resilience in the compression element, and the pressure cap or washer may further advantageously comprise one or more indicator tabs configured to be pushed in a forward direction, to visibly move from a first position to a second position, by the one or more of the protrusions of the compression element when a tension pressure applied on the pressure cap and the compression element has reached a predetermined pressure limit, thereby reducing the risk of over-compression, and simplifying the mounting procedure.

The pressure cap is advantageously used in combination with a compression element as described herein, but can also be used independently without a compression element.

A pressure cap or washer including an indicator tab can suitably be used together with a front end plate comprising a bowl part as described herein, but can also be used in other applications, for example in connection with a conventional front end plate of a hollow air filter, or in any other application where it is important to avoid too hard tightening in threaded engagement between fastening elements. In mounting of a hollow air filter on a mounting stand, such as for example a tripod too hard tightening may in a worst case scenario damage the mounting stand, which may as a consequence lead to difficulties in mounting a replacement filter or damage thereof. The indicator tab also facilitates the air filter installation in that it is very easy for a person installing the filter to know when the fastening elements have been sufficiently tightened, thus making the installation faster and more accurate.

The compression element including two or more protruding portions and the pressure cap or washer with the indicator tab form a pressure indicator assembly, which can also be used in many different applications, in addition to the above example relating to a bowl shaped front end panel. The compression element may provide an essentially flat rear surface that can act as a stable base for the pressure indicator washer. The resilient compression element is preferably made of resilient polymeric material, preferably thermoplastic elastomer material (TPE), such as thermoplastic polyurethane (TPU). The resilient compression element may suitably be made as an integral one piece element, and may be configured to interlock with an edge of the aperture in the bowl part to be attached to the bowl part. Thereby, the resilient compression element can also act as a gasket between the bowl part and the connection member (connection rod). The resilient compression element may preferably be obtained by co-injection molding together with the front end plate, which in the above embodiment is the bowl part of the front end plate.

The resilient compression element is capable of acting as a spring member in the front end plate, and is compressed to a certain stress during initial mounting. At low temperature, as the filter media supporting cage shrinks and the stress in the resilient compression element will decrease, causing it to increase in size and take up some of the gap to prevent leakage between the filter cartridge and the base plate. At high temperatures as the filter media supporting cage expands, stress in the resilient compression element will increase causing it to be compressed more. This additional compression in the resilient compression element gives the filter media supporting cage a bit more room to expand, reducing the net force it is exposed to.

Polymeric materials, such as thermoplastic elastomers, may also be affected by temperature, but because the resilient compression element is relatively small compared to the filter media supporting cage in a length direction, an expansion of the resilient compression element in the length direction will not essentially affect the performance of the filter cartridge. The fact that polymeric materials, including thermoplastic elastomers, may become harder at lower temperatures, can actually be an advantage since the resilient compression element will become more pliable at high temperatures flexing more when this is desired, and less pliable at lower temperatures when it is desired that it stays rigid, for example, when combined with the indicator tabs as part of the over-compression prevention. The resilient compression element also helps to compensate for the state of thermal expansion of the filter cartridge at the time of installation, i.e. if the filter cartridge is installed on a cold day, the resilient compression element will be harder and the indicator tab will pop prematurely so that when the temperature of the system cycles through to high temperature, there is not excessive load on the filter cartridge. Conversely, if the filter is installed on a hot day, the resilient compression element is soft and will cause the indicator tab to pop at a higher axial load reducing the risk of the gasket failing during filter shrinkage at lower temperatures.

The resilient compression element may also act as a shock absorbing system for vibrations and pulse energy caused by the pulse event, when used in a pulse filter.

The bowl part preferably includes a ramp portion adjacent to the flange part, said ramp portion being configured to be inserted into the front end opening and to fit into a front end opening of an air filter media supporting cage arranged on an interior side of the hollow air filter media pack, to facilitate assembly of air filter cartridge.

The flange part may suitably include an air filter media retaining recess configured to receive the front end of the hollow air filter media pack. The filter media pack may preferably be secured to the recess by means of suitable adhesive.

The filter media supporting cage can suitably be a cage assembly that comprises two or more cage wall members extending in a length direction from a first end to a second end, and which may have a latticework structure including column elements and beam elements, where the column elements provide stability in the length direction of the cage assembly and the beam elements connect the column elements and provide strength and stability in a circumferential direction. When the cage assembly is used in a pulse filter cartridge installed on a mounting stand, such as a tripod, the column elements of the wall members will also support the axial load exerted on the filter cage assembly. The cage wall members may further comprise one or more vane shaped column connecting sections as a part of the latticework The column connecting sheet elements and the beam elements can thus be arranged to connect the column elements at multiple points and thereby serve to stabilize the cage assembly, while still allowing an air flow to pass. The cage wall members may further include one or more cross bracing sections, as a part of the latticework, extending in a cage circumference direction, which may be perpendicular or at an angle to the length direction of the wall member, and may include inclined cross bracing elements extending between adjacent column elements, which may additionally decrease the risk of buckling of the cage during use.

As mentioned above, the present disclosure also relates to a pressure indicator washer and a pressure indicator assembly including the pressure indicator washer, as described above, which can be used in connection with a front end plate as described above, as well as in other situations where it is desired to effectively assemble components without risk of over-tensioning. For example, it can be used in connection with a conventional front end plate of the type commonly used in hollow filters that are closed at one end by the front end plate. Such filters are commonly used in pulse filter applications.

The pressure indicator washer comprising a main portion having a central opening configured to receive a connection rod of a mounting stand. The main portion is typically a disc shaped member, which has a front side that will be facing outward when the pressure indicator washer in used in an assembly or installation, and a rear side that will be facing rearward when assembled or installed. The indicator washer further comprises at least one indicator tab provided in the main portion. The indicator tab includes a contact portion protruding from the rear side of the main portion. The indicator tab is suitably configured to be pushed out from the front side of the main portion when a pressure applied on a rear side of the contact portion has reached a predetermined pressure limit.

The indicator tab may preferably comprise a weakened outline part, which is intended to break when a predetermined pressure is applied on the rear side of the contact portion of the indicator tab. The weakened outline part is preferably a perforation line with intermediate bridges, i.e. a series of slots or holes with intermediate bridges connecting a top part of the indicator tab with the surrounding material of the main portion of the washer. The material thickness or the width of the bridges is selected such that the bridges will break when a predetermined pressure is applied on the indicator tab, on the rear side thereof. Thereby, the bridges act as breakable links between the indicator tab and the main portion of the pressure indicator washer. Alternatively, the weakened outline can be a weakening line where the material connecting the main portion and an upper part of the indicator tab is thinner, such that it can break when predetermined pressure is applied on the rear side of the indicator tab. The indicator tab is suitably connected to the pressure washer by a hinge portion, such that it is retained in the washer also after having popped out.

The protruding contact portion of the indicator tab and the weakened outline part of the indicator tab are advantageously made of different materials. The material of the weakened outline part is selected to be brittle, so that it will break instantly when the predetermined pressure is applied. A suitably material for the weakened outline part of the indicator tab may be glass fibre filled nylon, and the entire washer except for the contact portion of the indicator tab may be made of that material. The contact portion may suitably be made of nylon.

The pressure indicator washer suitably comprises a contact area located on the front side of the main portion, said contact area surrounding the central opening and being configured to receive a force applied by a fastening element being attached to a connection rod when mounted. The fastening element may preferably be a nut threaded onto the connection rod when mounted.

In some embodiments, the pressure indicator washer may comprise only one indicator tab. This may be suitable when the pressure indicator washer is used in connection with a compression element having a design such that it supports the rear side of the washer in a balanced way.

In some other embodiments, the pressure indicator washer may comprise a plurality of pressure indicator tabs. This may be suitable when the washer is to be used on a substantially flat surface where no protruding elements are available for applying pressure on the rear side of the indicator tab. In that case, the contact portions may need to extend rearwardly beyond the pressure indicator washer such that pressure can be applied on the contact portion of the indicator tab also by a substantially flat surface.

The pressure indicator washer may be included in a pressure indicator assembly as described above, which assembly further comprises a compression element having a central opening and at least one protruding element. The central opening of the compression element and the central opening of the pressure indicator washer is configured to receive a connection rod. In the assembly, the pressure indicator washer is configured to be positioned onto the compression element such that the central opening of the pressure indicator washer coincides with the a central opening of the compression element when assembled. The protruding elements are directed toward the rear side of the pressure indicator washer, and the indicator tab of the pressure indicator washer has a position which is aligned with the position of at least one protruding element of the compression element. The compression element suitably includes a plurality of protruding elements distributed around the central opening. At least one of the protruding elements may suitably comprise a recess configured to receive a portion of the contact portion of the indicator tab arranged in the pressure indicator washer, in order to facilitate proper alignment of the pressure indicator washer with the compression element. The compression element is suitably a resilient compression element, and can be made of the materials described above.

The pressure indicator assembly may preferably comprise a base plate adapted to be positioned on a rear side of the compression element opposite to the pressure indicator washer. The base plate has a central opening for receiving a connection rod of a mounting stand, and may preferably have a circumferential flange adapted to engage with the compression element when assembled. The pressure indicator washer may suitably comprise a circumferential flange adapted to engage with the compression element when assembled. In this way the pressure indicator washer can form a self-contained unit together with the compression element and the base plate that can be used in any suitable application.

Further, the base plate may include an engagement portion adapted to engage with an opening in a front end plate of a hollow air filter to securely hold the pressure indicator assembly in position during installation. In case a base plate is not used, such an engagement portion can be provided on a rear side of the compression element or on the rear side of the pressure indicator washer.

The compression element may be provided as a separate component, sandwiched in the pressure indicator assembly, or may be an integrated part of the pressure indicator washer or the base plate.

As mentioned above the present disclosure also relates to an air filter front end plate configured to close off a front end of a hollow air filter media pack. The front end plate comprises a centre part and a flange part located along a periphery of the centre part, the centre part including a connection point located at the centre thereof and being configured to be connected to a front end of a mounting stand in an air filter arrangement, wherein a pressure indicator washer as described above is arranged at the a connection point. Advantageously, the pressure indicator washer is comprised in a pressure indicator assembly as described above, and if desired, the compression element may be joined with the air filter front end plate by adhesive or co-injection molding.

The present disclosure further relates to an air filter cartridge comprising an air filter front end plate described above, a hollow air filter media pack, and a rear end plate, and to an air filter arrangement comprising the air filter cartridge, a mounting stand, and an air filter base plate comprising an air flow opening, wherein the filter cartridge is fastened to the mounting stand and the rear end plate is directed toward the base plate, and wherein a front end of the mounting stand is connected to the air filter front end plate of the filter cartridge at a connection point, such that the connection rod is inserted through the central opening of the pressure indicator washer and a fastening element is tightened with respect to the connection rod, wherein the indicator tab is adapted to be pushed out from the front side of the main portion of the pressure indicator washer when a pressure applied on a rear side of the contact portion of the washer has reached a predetermined pressure limit. A second air filter cartridge which is open in both ends can be arranged between the air filter cartridge and the air filter base plate. The connection rod is suitably a part of the mounting stand, said mounting stand preferably being a tripod.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows a cross-sectional view of a front end plate according to the present disclosure and also shows the connection member 135 and nut 19 belonging to the mounting stand;

FIGS. 2a and 2b shows cross-sectional views of the front end plate and connection member in FIG. 1, with enlargement view of the indicator tab in the initial first position (FIG. 2a) and the popped second position (FIG. 2b);

FIG. 3 shows a cross-sectional perspective view of an air filter arrangement including two filter cartridges on top of each other, where the top cartridge includes a front end plate according to the present disclosure.

FIG. 4 shows a top view of a pressure indicator washer according to the present disclosure;

FIG. 5 shows a detail of FIG. 4;

FIG. 6 shows a cross-sectional perspective view of the pressure indicator washer of FIG. 4;

FIG. 7 shows a cross-sectional perspective view of the pressure indicator washer where the indicator tab has popped;

FIG. 8 shows a cross-sectional perspective view of a pressure indicator assembly according to the present disclosure;

FIG. 9 shows a cross-sectional perspective view of a front end plate according to the present disclosure;

FIG. 10 shows a perspective view of a compression element seen from the rear side;

FIG. 11 shows a perspective view of a compression element seen from the front side.

### Example Embodiments

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

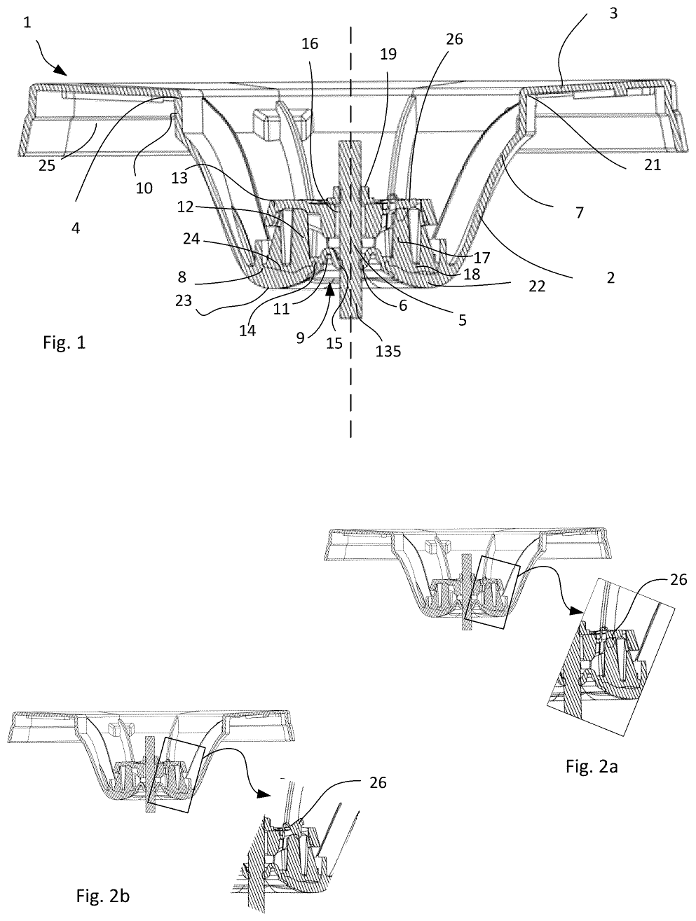

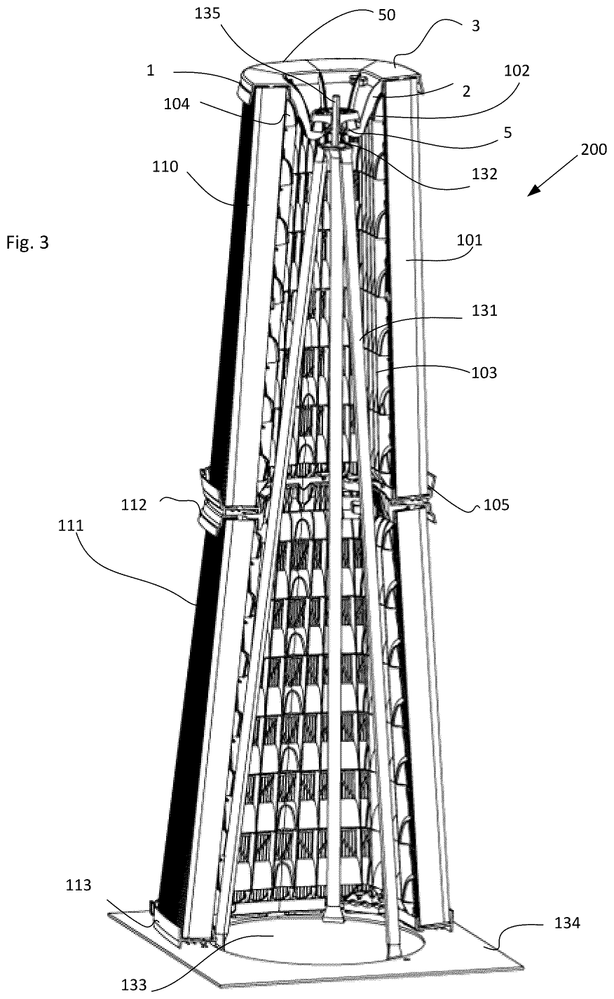

FIG. 1 shows a front end plate according to an example embodiments of the present disclosure. FIG. 3 illustrates how the front end plate can be attached to a mounting stand in an air filter arrangement. The air filter front end plate 1 is configured to close off a front end 102 of a hollow air filter media pack 101 (FIG. 3). The front end plate comprises a bowl part 2 and a flange part 3 located along a periphery 4 of the bowl part 2. The bowl part includes a connection point 5 located at the centre of the bowl part, and is configured to be connected to a front end 132 of the mounting stand 131 in an air filter arrangement 200. The bowl part 2 extends from a forward end 21 toward a rearward end 22 of the air filter front end plate and is configured to be at least partially inserted into a front end opening 102 of the hollow air filter media pack 101, and wherein the bowl part 2 has a recurved shape with a first curved portion 7 located closer to the forward end 21 and a second curved portion 8 located closer to the rearward end 22, wherein the first curved portion 7 has a convex shape in relation to a centre line through the air filter front end plate and the second curved portion 8 has a concave shape in relation to the centre line, whereby the connection point 5 is located in a position forward of the second curved portion 8. The second curved portion 8 of the bowl part 2 forms a recess 9 on the rearward side 23 of the air filter front end plate, which is adapted to receive the connecting member 135 that is attached to the mounting stand 131 (FIG. 3).

The connection point 5 comprises an aperture 11 and a connection arrangement located on the forward side 24 of the bowl part 2. The connection arrangement comprises a pressure cap 13 and a resilient compression element 12 arranged between the bowl part 2 and the pressure cap 13. The resilient compression element 12 is an integral one piece element, preferably made of resilient polymeric material, and interlocks with the edge 14 of the aperture 11 to be attached to the bowl part. The bowl part and the resilient compression element are preferably co-injection molded.

Two or more protruding portions 17 extend in a forward direction from the base portion 18 of the resilient compression element 12, which also has a central opening 15 for receiving a connection member in the form of a connection rod 135. The pressure cap 13 also has a central opening 16 for receiving the connection rod 135. The pressure cap 13 is provided with one or more indicator tabs 26, which are configured to be pushed in a forward direction by the compression element 12 when a pressure applied on the pressure cap 13 and the compression element 12 has reached a predetermined pressure limit. FIG. 2a the indicator tab in the initial position and FIG. 2b shows it the subsequent popped position;

The bowl part 2 includes a ramp portion 10 adjacent to the flange part 3, which is configured to be inserted into the front end opening 102 of the of the filter media pack and to fit into the front end opening 104 of the air filter media supporting cage 103, which is arranged inside the filter media pack 101. The flange part 3 includes an air filter media retaining recess 25 configured to receive the front end of the hollow air filter media pack 101.

FIG. 3 shows a cross-sectional perspective view of an air filter arrangement including two filter cartridges 110 and 111 on top of each other, and illustrates an example of how the filter cartridge 110 can be mounted in an air filter arrangement. The air filter arrangement is preferably a pulse filter arrangement. The supporting cage is arranged inside the hollow filter media pack 101, and a front end panel 23 closes the hollow air filter media at the front end 104 thereof. A mounting stand 131 in the form of a tripod is attached over an air passage opening 133 in a base plate 134. The two cartridges 110,111 are placed over the tripod with the rear cartridge 111 closest to the opening 133, and its rear end plate 113 in abutment with the surface of the base plate 134. The front cartridge 110 is positioned so that its rear end plate 105 is in contact with the front end plate 112 of the rear cartridge 111. A connection member in the form of a connection rod 135 at the front end 132 of the tripod is inserted through the front end plate of the front cartridge and fastened by mean of for example a nut 19 (shown in FIG. 1). Other ways of mounting the air filter cartridges can be contemplated. In FIG. 3, the illustrated front end plate has the configuration of the front end plate illustrated in FIGS. 1, 2a and 2b. However, an air filter arrangement including a substantially flat front end plate would include the same components, apart from the bowl shape of the front end plate.

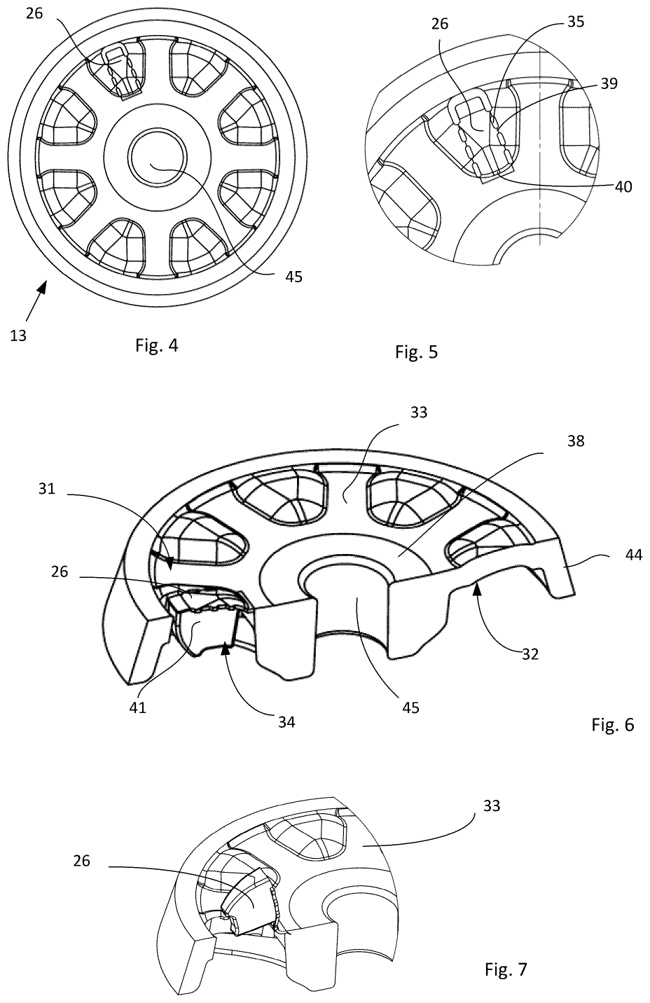

FIGS. 4-7 illustrate a pressure indicator washer according to the present disclosure. The pressure indicator washer 13 comprises a main portion 33 having a front side 31 and a rear side 32, and a central opening 45 configured to receive a connection rod 135 of a mounting stand (as illustrated in FIG. 3). An indicator tab 26 is provided in the washer including a contact portion 41 protruding from the rear side of the main portion. The indicator tab 26 is configured to be pushed out from the front side of the main portion as illustrated in FIG. 7, when a pressure applied on a rear side 34 of the contact portion 41 has reached a predetermined pressure limit.

FIGS. 4 and 5 show how the indicator tab 26 comprises a weakened outline part 35, in the form of a perforation line with intermediate bridges 39. The indicator tab 26 is connected to the pressure washer by a hinge portion 40. A contact area 38 is located on the front side 31 of the main portion 33, and surrounds the central opening 45 as shown in FIG. 6. The contact area is configured to receive a force applied by a fastening element 19 being attached to a connection rod 135 when mounted. FIG. 3 shows fastening of the washer by means of a nut 19 threaded onto the connection rod 135. In FIG. 6 the indicator tab is in its initial state, i.e. not yet popped, and in FIG. 7 the indicator tab has popped;

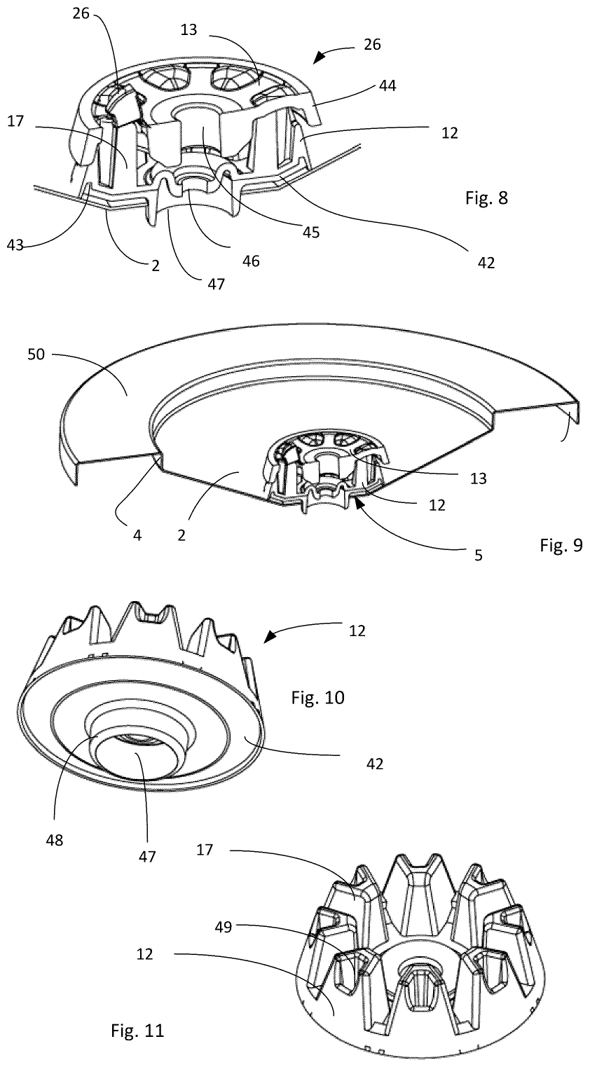

FIG. 8 shows a pressure indicator assembly according to the present disclosure, and FIG. 9 shows a front end plate including a pressure indicator assembly. The pressure indicator assembly comprises the pressure indicator washer shown in FIGS. 4-7 and a compression element 12 having a central opening 46 and at least one protruding element 17. As shown in FIGS. 8 and 9, the pressure indicator washer 13 is positioned onto the compression element 12 such that the central opening 45 of the pressure indicator washer 13 coincides with the a central opening 46 of the compression element in the assembly. The central opening 46 of the compression element 12 and the central opening 45 of the pressure indicator washer 13 are configured to receive a connection rod 135 as illustrated in FIG. 3. The protruding element 17 is directed toward the rear side 32 of the pressure indicator washer 13, and the indicator tab 26 has a position which is aligned with the position of the protruding element 17 of the compression element 12.

As shown in FIG. 10, the pressure indicator assembly can comprise a base plate 42 adapted to be positioned on a rear side of the compression element 12 opposite to the pressure indicator washer. The base plate 42 has a central opening 47 and may also include an engagement portion 48 adapted to engage with an opening in a front end plate 50 of a hollow air filter (FIGS. 8 and 9) to securely hold the pressure indicator assembly in position during installation. The base plate may further include a circumferential flange 43 adapted to engage with the compression element 32 when assembled, as shown in FIG. 8. FIGS. 8 and 9 also show how the pressure indicator washer 13 comprises a circumferential flange 44 adapted to engage with the compression element 12 when assembled. As shown in FIG. 11, the compression element 12 includes a plurality of protruding elements 17 distributed around the central opening 46. The protruding elements can comprise a recess 49 configured to receive a portion of the contact portion of the indicator tab.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

The listing of claims replaces all previous versions of the claims:

1. An air filter front end plate configured to close off a front end of a hollow air filter media pack, the front end plate comprises a bowl part and a flange part located along a periphery of the bowl part, said bowl part including a connection point located at the center of the bowl part and being configured to be connected to a front end of a mounting stand in an air filter arrangement, wherein the bowl part extends from a forward end toward a rearward end of the air filter front end plate and is configured to be at least partially inserted into a front end opening of the hollow air filter media pack, and wherein the bowl part has a recurved shape with a first curved portion located closer to said forward end and a second curved portion located closer to said rearward end, wherein said first curved portion has a convex shape in relation to a center line through the air filter front end plate and said second curved portion has a concave shape in relation to said center line, whereby the connection point is located in a position forward of the second curved portion.

2. The air filter front end plate of claim 1, wherein the second curved portion of the bowl part is configured to form a recess on a rearward side of the air filter front end plate, said recess being adapted to receive a connecting member attached to the mounting stand.

3. The air filter front end plate of claim 1, wherein the connection point comprises an aperture and a connection arrangement is located on a forward side of the bowl part, said connection arrangement comprising a resilient compression element and a pressure cap, the resilient compression element being arranged between the bowl part and the pressure cap.

4. The air filter front end plate of claim 3, wherein the resilient compression element includes two or more protruding portions extending in a forward direction from a base portion.

5. The air filter front end plate of claim 3, wherein the resilient compression element has a central opening configured to receive a connection member to be inserted through the aperture in the bowl part.

6. The air filter front end plate of claim 3, wherein the resilient compression element is an integral one piece element, made of resilient polymeric material.

7. The air filter front end plate of claim 3, wherein the resilient compression element configured to interlock with an edge of the aperture to be attached to the bowl part, and is obtained by co-injection molding.

8. The air filter front end plate of claim 3, wherein the pressure cap has a central opening configured to receive a connection member.

9. The air filter front end plate of claim 3, wherein the pressure cap comprises one or more indicator tabs configured to be pushed in a forward direction by the compression element when a pressure applied on the pressure cap and the compression element has reached a predetermined pressure limit.

10. The air filter front end plate of claim 1, wherein the bowl part includes a ramp portion adjacent to the flange part, said ramp portion being configured to be inserted into the front end opening and to fit into a front end opening of an air filter media supporting cage arranged on an interior side of the hollow air filter media pack.

11. The air filter front end plate of claim 1, wherein the flange part includes an air filter media retaining recess configured to receive the front end of the hollow air filter media pack.

12. An air filter cartridge comprising the air filter front end plate of claim 1, an air filter media supporting cage, a hollow air filter media pack, and a rear end plate, wherein the air filter media supporting cage is arranged on an interior side of the hollow air filter media pack and the air filter front end plate is inserted into a front end opening of the air filter media supporting cage and into the front end opening of the air filter media pack.

13. An air filter arrangement comprising the air filter cartridge of claim 12, a mounting stand, and an air filter base plate comprising an air flow opening, wherein the filter cartridge is fastened to the mounting stand and the rear end plate is directed toward the base plate, and wherein a front end of the mounting stand is connected to the air filter front end plate of the filter cartridge at the connection point.

14. The air filter arrangement of claim 13, wherein a second filter cartridge with an open front end plate is arranged between the air filter cartridge and the base plate.

15. The air filter arrangement of claim 13, wherein the mounting stand is a tripod.

16. A pressure indicator washer comprising a main portion having a central opening configured to receive a connection rod of a mounting stand, said main portion having a front side and a rear side, said indicator washer further comprising at least one indicator tab provided in said main portion, said indicator tab including a contact portion protruding from the rear side of said main portion.

17. The pressure indicator washer of claim 16, wherein said indicator tab is configured to be pushed out from the front side of the main portion when a pressure applied on a rear side of the contact portion has reached a predetermined pressure limit.

18. The pressure indicator washer of claim 16, wherein the indicator tab comprises a weakened outline part, said weakened outline part being a perforation line with intermediate bridges or a weakening line.

19. The pressure indicator washer of claim 18, wherein the tab is connected to the pressure washer by a hinge portion.

20. The pressure indicator washer of claim 16, wherein protruding contact portion and a weakened outline part of the indicator tab are made of different materials.

21. The pressure indicator washer of claim 16, further comprising a contact area located on the front side of the main portion, said contact area surrounding the central opening and being configured to receive a force applied by a fastening element being attached to a connection rod when mounted, said fastening element preferably being a nut threaded onto the connection rod when mounted.

22. The pressure indicator washer of claim 16, comprising a plurality of pressure indicator tabs.

23. A pressure indicator assembly comprising the pressure indicator washer of claim 16 and a compression element having a central opening and at least one protruding element, said central opening of the compression element and said central opening of the pressure indicator washer being configured to receive a connection rod, wherein the pressure indicator washer is configured to be positioned onto the compression element such that the central opening of the pressure indicator washer coincides with the a central opening of the compression element when assembled, and the at least one protruding element is directed toward the rear side of the pressure indicator washer, and wherein the indicator tab of the pressure indicator washer has a position which is aligned with the position of the at least one protruding element of the compression element.

24. The pressure indicator assembly of claim 23, wherein the compression element is a resilient compression element.

25. The pressure indicator assembly of claim 23, further comprising a base plate adapted to be positioned on a rear side of the compression element opposite to the pressure indicator washer, said base plate having a central opening and having a circumferential flange adapted to engage with the compression element when assembled.

26. The pressure indicator assembly of claim 23, wherein the pressure indicator washer comprises a circumferential flange adapted to engage with the compression element when assembled.

27. An air filter front end plate configured to close off a front end of a hollow air filter media pack, the front end plate comprises a center part and a flange part located along a periphery of the center part, said center part including a connection point located at the center thereof and being configured to be connected to a front end of a mounting stand in an air filter arrangement, wherein a pressure indicator washer of claim 16 is arranged at the a connection point.

28. The air filter front end plate of claim 27, wherein the pressure indicator washer is comprised in a pressure indicator assembly according to claim 23.

29. An air filter cartridge comprising an air filter front end plate according to claim 27, and a hollow air filter media pack, and a rear end plate.

30. An air filter arrangement comprising an air filter cartridge according to claim 29, a mounting stand, and an air filter base plate comprising an air flow opening, wherein the filter cartridge is fastened to the mounting stand and the rear end plate is directed toward the base plate, and wherein a front end of the mounting stand is connected to the air filter front end plate of the filter cartridge at a connection point, such that the connection rod is inserted through the central opening of the pressure indicator washer and a fastening element is tightened with respect to the connection rod, wherein the indicator tab is adapted to be pushed out from the front side of the main portion of the pressure indicator washer when a pressure applied on a rear side of the contact portion of the washer has reached a predetermined pressure limit.

31. The air filter arrangement of claim 30, wherein a second air filter cartridge is arranged between the air filter cartridge and the air filter base plate.

32. The air filter arrangement of claim 30, wherein the connection rod is a part of a mounting stand, said mounting stand preferably being a tripod.
